(19) United States
(12) Patent Application Publication
(10) Pub. No.: US 2002/0100825 A1
(43) Pub. Date: Aug. 1, 2002

(54) Truck mounted straw handling and distribution system

(76) Inventor: Edward Gregory, Pulaski, VA (US)

Correspondence Address: WOODS, ROGERS & HAZLEGROVE, PLC., SUITE 300, 250 WEST MAIN STREET, CHARLOTTESVILLE, VA, 22902-2964, US

(21) Appl. No.: 10/059,284

(22) Filed: Jan. 29, 2002

Related U.S. Application Data
(60) Provisional application No. 60/264,837, filed on Jan. 29, 2001.

(51) Int. Cl. B02C 19/12

(52) U.S. Cl. 241/60; 241/101.76; 241/605

(57) ABSTRACT

A system is provided for the loading, transporting, feeding one or more bales of crop material such as corn stalks, straw, hay or grasses, particularly large cylindrical bales, and the subsequent controlled distribution of straw torn from said bales. More specifically, the disclosed invention is a vehicle mounted mechanical straw distribution system comprising a boom arm adapted to handle large cylindrical bales of crop materials, a mounted straw blower which breaks up a bale and blows the straw, and a versatile discharge spout allowing the blower operator to efficiently distribute straw over large areas such as road rights of way from the moving vehicle. The straw distribution is primarily for erosion control or other ground cover purposes. Two persons are required for operation of the system, one to drive the truck and operate the boom arm and the other to operate straw blower. Unlike conventional systems, this single unit is capable of loading and feeding large cylindrical bales without the need for supporting vehicles such as forklifts or tow vehicles.

Applicant claims priority for this application to U.S. Provisional Application No. 60/264837 filed on Jan. 29, 2001.

### FIELD OF THE INVENTION

The invention described herein generally relates to a mechanical straw distributor. More specifically, the invention is a vehicle mounted boom arm adapted to handling large cylindrical bales of crop materials, such as corn stalks, straw, hay or grasses, combined with a mounted straw blower which breaks up a bale and blows the straw, thereby allowing an operator to efficiently distribute straw over large areas such as road rights of way from the moving vehicle. The straw distribution is primarily for erosion control or other ground cover purposes. Two persons are required for operation of the system, one to drive the truck and operate the boom arm and the other to operate straw blower.

### DESCRIPTION OF THE RELATED ART

In certain agricultural and construction projects, such as the construction of roadways, large areas of soil become exposed. If the soil is not quickly protected, it will erode through normal weathering processes. The usual method used to prevent erosion is to prepare the soil as a seed bed, disperse grass seed, sometimes with fertilizer, and cover the soil with a ground cover material or mulch. The ground cover material, such as straw or hay or other crop material, provides protection from the elements for the dispersed seed, keeps the moisture in the seed bed, and prevents erosion of the soil while the seed takes root.

Currently, bales of straw are spread with the use of straw blowers which are hitched to a tractor or other vehicle and pulled or, in one case, self propelled, slowly beside the seed bed. Examples of the current state of the art are the Finn Corporation's Straw Blower Models B-260, B-70, and B-40. Blowers such as these require several persons to move the small square bales (40 lbs.) to the blower for break up and disbursement of the straw as well as an operator of the blower and an operator of the tow vehicle. These Finn Corporation Straw Blowers are described at www.finncorp.com. Other similar conventional towed straw blowers include the Ranch Power Milcher M90-4045T and M65-D020 (refer to www.reinco.com/html/prod-index.html for a description), among others.

Another towed straw blower is the Vermeer Top Gun Processor which processes large cylindrical bales of straw (1000 to 1500 lbs.) and is designed to be pulled behind a large farm tractor in agricultural applications. The operator of this straw blower is required to be on the tractor which leads to difficulty in controlling the tractor and the straw blower at the same time.

U.S. Pat. No. 5,340,040 discloses a machine for dispersing straw using large round bales. This, like the other conventional machines, requires a separate vehicle to pull the machine. Moreover, the operator of the tractor cannot easily see to effectively operate the straw blower. Additionally, like the other conventional towed machines, a vehicle to pull the machine as well as an additional fork lift or separate vehicle containing a boom arm is required for handling the large cylindrical bales. It would be advantageous to provide a single vehicle mounted machine to eliminate the need to tow the blower and to eliminate the need for support vehicles such as forklifts to load large bales.

U.S. Pat. No. 6,027,054 discloses a machine for dispersing straw using cylindrical bales (1000 lbs.). The disclosed machine while being self propelled while in operation cannot be operated or transported to new locations by means other than by a tow vehicle. The propulsion mechanism disclosed is a hydraulic motor which drives the front wheels. Because of the weight distribution (the blowing mechanism and driver sit on the rear of the machine) this front wheel drive mechanism is not optimal in hilly terrain. The hydraulic drive mechanism is designed to move the vehicle at slow speeds (less than 10 mph) during the dispersing of the straw. It cannot power the vehicle over that speed and is not useful for merging into traffic or transporting the machine between job sites. The disclosed machine does not have the ability to handle large bales without resorting to another vehicle with a boom arm or forklift and cannot handle very large cylindrical bales (1500 lbs. 6′ in diameter and 5′ in length). Moreover, the operator of the disclosed machine while in operation is exposed to the weather and is not positioned optimally to see the dispersing and application of the straw. The sole operator of the disclosed machine must necessarily sit facing forward, with traffic approaching from the rear, making it impossible to observe approaching traffic. Also, the sole operator is required to disperse the straw and is limited to certain angles on the side because of the wind problem of blowing straw from a moving vehicle. If straw is blown forward of the machine, it tends to fall back on the operator. This problem is exacerbated in windy conditions. It would be advantageous to provide a machine to distribute straw in which the operator is protected from the elements as well as from the blowing straw and chaff and in which the operator is positioned to view traffic approaching the machine while it is in use. It would be further advantageous to provide a machine to operate at faster speeds than conventional towed blowers.

Problems arise from the use of all of the conventional towed straw blowers. Many are designed to operate at very slow speeds by numerous individuals moving 40 lbs. straw bales, operating the vehicle, and operating the straw blower. One, the self propelled machine, is designed to be operated by one person who must drive, watch traffic, monitor the break up of the bales, and disperse the straw, all at the same time. Along busy highways, these slow moving vehicles or blower in tow become a safety hazard, not only for those operating the straw blower but also for the traveling public. The usual application of straw as ground cover occurs along roads, and highway which, for safety, requires mobile lane closures with a crash cushion and shadow vehicle or permanent lane closures with traffic cones and barriers. As a result, merging easily in and out of traffic and accelerating from and decelerating into the closed lane areas becomes important for the safety of the traveling public and the operator(s) of the straw dispersing equipment. Moreover, conventional systems require the blowers to be towed to job sites. Thus, a tow vehicle must maneuver, sometimes in traffic, stop and hook up the trailer (hitch and electrical systems). This exposes personnel to additional time in the hazardous work zone and is not productive time in the dispersing of straw. Applicant has found no prior art disclosing a self contained straw dispersing unit providing the power, speed and agility to safely merge with traffic and access closed lane areas. Vehicles towing conventional straw distributors simply are less safe. It would be advantageous to provide a straw distribution machine which can travel at highway speed, accelerate and decelerate to accommodate traffic, and maneuver easily when used with lane closure systems.

In addition to these safety issues, the conventional methods are highly labor intensive, requiring numerous people for the application of the ground cover. In the use of conventional towed machines, several laborers are required to handle and feed the square bales, one to operate the blower, one to drive the truck, and one to operate a truck carrying numerous bales to put through the system. In the use of the self propelled machine disclosed in U.S. Pat. No. 6,027,254, there is required an operator of the machine, the operator of a forklift or other vehicle to handle large cylindrical bales, and an operator with a truck with additional bales. It would be advantageous to provide a straw distribution machine which requires only two operators onboard the machine, one to drive and handle the bale loading mechanism and one to operate the blower.

Maximum use of conventional straw blowers allow the coverage, at Department of Transportation specification, of approximately 16 acres per day. All of the conventional machines are subject to the vagaries of the weather as well as daylight as limiting factors in their continued use. It would be advantageous to provide a straw distribution system which may be operated in all reasonable weather conditions and which may cover up to 40 acres per day.

The use of large cylindrical bales (1000-1500 lbs.) is more economical than the use of square bales (40 lbs.). At today's prices, large cylindrical bales cost $25 while small square 40 lbs. bales cost $2.50. It takes 37 small 40 lbs. bales at a cost of $93.75 to produce the same amount of ground cover as one large cylindrical bale (1,500 lbs.) at a cost of $25. Thus, it would be advantageous to provide a straw distribution machine which could easily use large bales for distribution.

Moreover, there are limitations as to the distance ground cover can be blown and grade of slopes which can be accessed by towed straw blowers because of the need to maintain a safe and level working space for the hay handlers and operators. It would be advantageous to provide a straw distribution machine which may be operated on all terrains and can blow straw a greater distance than conventional blowers.

### SUMMARY OF THE INVENTION

The present invention provides a mounted vehicle comprising a straw blower combined with a hay handling boom capable of handling large cylindrical bales. This system is capable of moving at highway speeds, allows for a less labor intensive operation requiring fewer personnel, provides greater safety for those operating the system, provides greater safety for those traveling near the operation, and allows straw to be dispersed more evenly and effectively over the coverage area, regardless of the grade of the target area of distribution.

To remedy the various problems with conventional straw blowers, this self-contained unit creates one compact unit instead of three for handling large, heavy, cylindrical bales, allows transportation at highway speeds within the Department of Transportation width limitations, and allows for the dispersing straw effectively from a moving vehicle. The disclosed invention is designed to be operated by two persons, one to drive the truck and control the bale handling boom (the controls of which may be either within or without the cab of the truck) and one to control the breakup of the bales and distribution of the straw. The need for a tow vehicle is eliminated by the disclosed invention as are all of the safety issues created by tow vehicles.

A further object of the invention is that the self-contained unit contains a climate controlled cab for the straw blower operator. All controls are easily accessible and the operator can monitor those controls, the intake, and the application rate of the straw with complete visibility of the work area and in fully environmentally controlled comfort. Unlike the Vermeer Top Gun Processor, metal screens are used on the sides of the blower unit allowing for greater visibility of the cylindrical bale breakup mechanisms by the operator. Additionally, the climate controlled cab is placed in a high position to allow for greater visibility (360°) of the straw distribution, the bale intake, and the work zone traffic. The blower operator's cab, although it could easily face toward the front of the vehicle, is preferred to face the rear of the vehicle. This allows the blower operator to more accurately and efficiently disperse the straw with more consistency by not having to deal with wind resulting from the moving vehicle. Furthermore, the blower operator can see traffic approaching from the rear of the machine and assist the driver with safety issues which may arise, particularly when merging with the oncoming traffic. These features, combined with radio communication between the driver and blower operator, provides for improved safety in the operation of the system.

Another object of the present invention is to improve the horizontal and vertical turning limitations of the discharge spout, enabling the blower operator to distribute straw over a greater area without repositioning the machine. Moreover, the improved horizontal and vertical motion of the discharge spout allows the blower operator to distribute straw on steeper slopes and to areas which are more difficult to access or impossible to access with conventional machines.

Another object of the present invention is to provide restriction bars at the straw intake which allow for greater control and more continuity of material intake flowing into the straw blower. These restriction bars provide for more even and more easily regulated intake flow (thus more easily regulated flow of the discharged straw) as well as eliminating potential for stalling of the blower engine. Material feeds are controlled by increasing the number of restriction bars to reduce the intake of the straw into the feed rotor. Department of Transportation standards for depth of ground cover (requiring 4,000 lbs. of straw per acre) can be obtained by adjusting the number of restriction bars. The restriction bars used in the disclosed machine reduce straw intake at the bale break up mechanism by as much as 50% of the material feed into the Vermeer Top Gun Processor. With the straw intake controlled at the break up mechanism, a greater horsepower engine than used in conventional straw blowers can be used to power the blower thus allowing distribution of straw to a distance from the machine in excess of 250 feet, some 75% further than the Vermeer Top Gun Processor. A John Deere 200 hp diesel engine was used in the first prototype of the disclosed machine. This increased horsepower additionally powers a self-contained hydraulic unit used by all functions of the blower such as the rotation of the discharge spout, the power to the intake feed rollers, power to the material handling boom, as well as operation of the climate control features of the operator's cab.

Another object of the invention is to provide a loading mechanism, being a hydraulic boom and hay grapple in the preferred embodiment, as an integral part of the system. The location of this boom on the system at the fore end of the truck bed allows for greater loading efficiency with total visibility by the operator of the boom arm (in some cases, the driver). Additionally, loading can occur from a transport vehicle transporting large cylindrical bales or from any other point as it is not limited to ground level loading.

Another object of the invention is to allow the straw dispersing operation to proceed in inclement weather. No conventional machine can be effectively operated in rain or other inclement weather. The provision of an environmentally controlled operator's cab and a two way radio communication system between the straw blower operator and the driver of the truck provide for safe and comfortable operation in any weather.

Another object of the invention is to allow the system to be deployed to job sites at highway speed, without towing. The self contained invention is fully highway legal and capable of highway travel complying with all lighting, width, mobility, and weight regulations, both state and federal.

Another object of the invention is to allow greater efficiency, uniformity, and speed in the application of ground cover. With the use of the disclosed machine, as much as 40 acres per day can be covered under DOT standards as opposed to 16 acres per day with conventional machines.

Yet another object of the invention is to allow the disbursement of straw a greater distance from the machine, and thus a greater area, than now available with conventional blowers.

Other objectives, advantages, and pertinent features of the present invention will become apparent from the following detailed description, which when taken in conjunction with the drawings attached, discloses a preferred embodiment of the present invention.

### BRIEF DESCRIPTION OF THE DRAWINGS

The invention will be described in detail hereunder with reference to the accompanying drawing figures wherein:

FIG. 1. shows a side view (driver's side) of the vehicle mounted straw distribution system;

FIG.2. shows a side view (rider's side) of the system;

FIG.3. shows the vertical movement of the discharge spout;

FIG.4. shows a top view of the system and the horizontal rotation of the discharge spout.

### DETAILED DESCRIPTION OF THE INVENTION

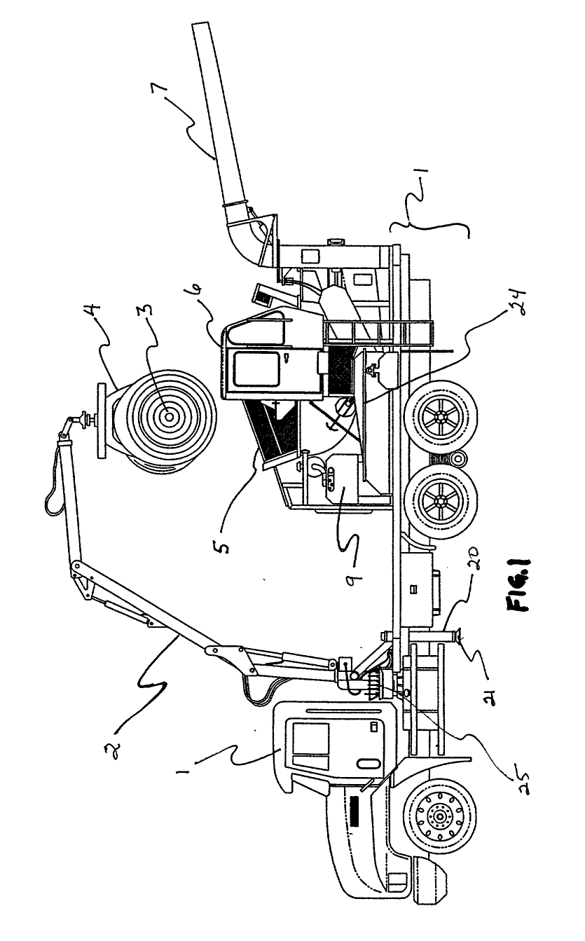

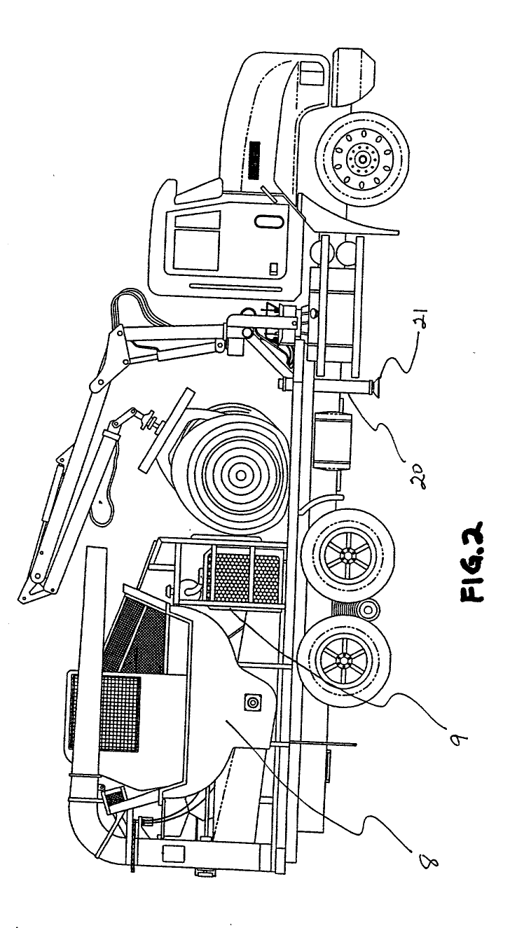

As shown in FIG. 1, a flat bed truck 1 is provided capable of holding at least 9,000 lbs. on its bed and capable of operating at highway speeds. At the fore-end of the flat truck bed, immediately behind the truck cab, a loading boom 2 is provided with a special hay grapple 4 at its operational end to pick up, store, handle, and load into the intake 5 of the straw blower a cylindrical bale of straw 3. At the rear end of the flat bed, a straw blower comprising an intake, intake flow control means (restriction bars and adjustable rotor bars), a straw breakup mechanism, a blower mechanism, and a discharge spout 7 is provided. All of the controls to the straw blower are contained in a climate controlled blower operator's cab 6 which is positioned for optimal viewing of the bale loading and straw dispersing process. The straw blower, as well as the hydraulics for the handling boom 2, and the climate controlling mechanisms for the operator's cab 6 are powered by a 200 horsepower diesel motor 9. Also shown on FIGS. 1 and 2 are two telescoping hydraulic stabilizers 20 used in steep terrain during operation of the bale handling boom. These telescoping stabilizers 20 are hydraulically powered and operated from the control area of the hydraulic boom 25 (located either in the truck cab or, as shown, exterior to the truck cab). The stabilizer foot 21 is hydraulically lowered to contact the surface on which the vehicle sits. Thus, the bale handling boom 2 is stabilized by the telescoping stabilizers' 20 direct contact with the surface on both sides of the truck 1 as opposed to relying on stability provided by the suspension system of the truck 1. While use of these telescoping stabilizers on trucks in excess of 26,000 gross vehicle weight, their use on lighter vehicles is required to safely and easily handle very large cylindrical bales (1,500 lbs.).

FIG. 2 shows the radiator for the 200 horsepower motor 9 as well as the intake side of the straw blower showing specifically the housing for the bale breakup mechanism 8. To transfer power and torque to the flail bar 14 that grinds the bales (and the two rotor bars 12 and 15), conventional sheaves or pulleys are insufficient. A 200 horsepower engine causes slippage when connected to the straw blower mechanisms with conventional sheaves or pulleys. Thus, the disclosed invention contains a poly chain belt drive system comprising a synchronized drive belt made of fiberglass and containing regularly distributed teeth which mesh with opposing teeth on each pulley that is driven by the belt, much the same as a timing belt on a car. Manufacturers of such poly chain systems are Browning or the Gates Rubber Company.

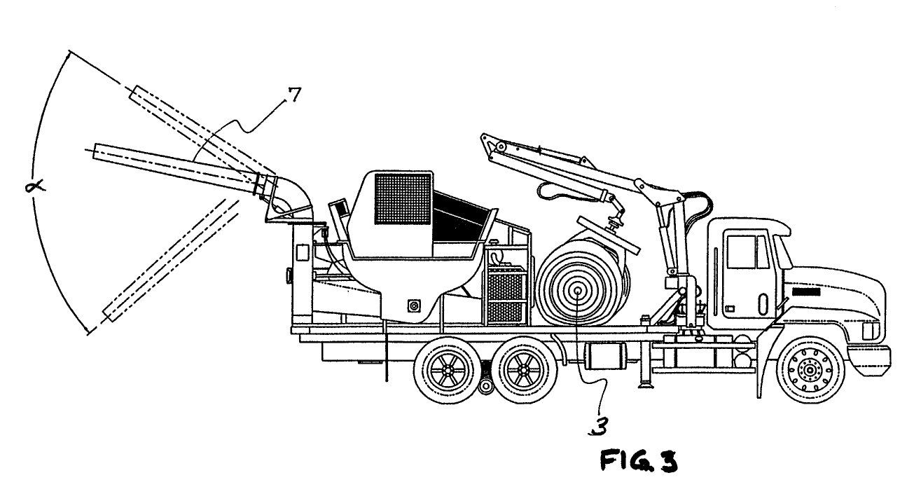

FIG.3 shows the vertical rotation of the discharge spout 7 across the range of angle alpha to have a maximum vertical limitation of approximately 75 degrees above horizontal and approximately 75 degrees below horizontal. FIG. 3 also shows the storage of a second cylindrical bale 3 by the bale handling boom 2 and grapple 4, so that the machine is capable of carrying one large cylindrical bale for future use as well as the one large cylindrical bale being broken up in and disbursed by the straw blower mechanism.

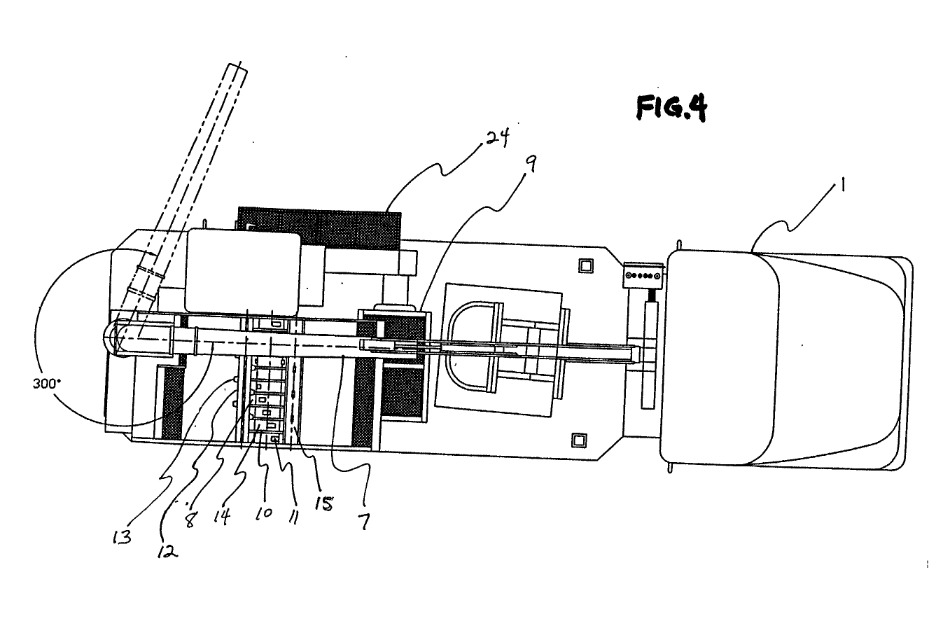

FIG. 4 shows a top view of the system, specifically showing the 300 degree horizontal rotational aspects of the discharge spout 7. FIG. 4 also reveals the material feed restriction bars in the break up mechanism 8 which allow for control of the intake of the straw, allowing for more even and consistent disbursement of the straw as described. The specific feed and breakup mechanism 8 of the straw blower comprises two free floating variable speed (clockwise and counter-clockwise) parallel rotor bars 12 and 15 regularly interspersed with flanges or teeth 13 separated from a flail bar 14 regularly interspersed with teeth or hinged flails 11 by restriction bars 10, all contained in a housing for the break up mechanism 8 providing access for and containment of a large cylindrical bale 3 with the rotor bars 12 and 15 and flail bar 14 powered by the 200 hp engine 9 via the poly chain drive belt and pulleys (not shown). Said rotor bars 12 provide bottom support for the large cylindrical bale 3 and are mechanically turned in unison at the same speed in the same direction. Flail bar 14 with teeth or hinged flails 11 is positioned below the rotor bars 12 and 15 and restriction bars 10 and centered between and parallel to the rotor bars 12 and 15. Flail bar 14 is mechanically turned by the engine 9 in the same direction as the rotor bars 12 and 15 so that the teeth 13 of the flail bar 14 tear straw from the bottom of the bale which is turning in the opposite direction of the flail bar 14. The teeth 13 then drop the 10 straw into the blower input or feeder. Unlike any conventional straw blower with similar mechanisms the number of restriction bars 10 between the rotor bars 12 and 15 and the flail bar 14 can be increased or decreased by being removably attached (or detached) at connections in the breakup mechanism housing 8. If the number of restriction bars 10 are increased, the amount of straw grabbed by the flail bar teeth 13 is reduced and less straw is put into the blower. Conversely, reducing the number of restriction bars 10 increases the amount of straw grabbed by the flail bar teeth 13 and the more straw is fed into the blower, increasing out put of the blower and the straw ground cover depth per unit time.

Also, adding flexibility for the adjustment of the intake to the straw blower mechanism (thus, the straw output of the blower mechanism) is the ability to adjust the rotor bars 12 and 15 upwards and downwards viz a viz the flail bar 14 to adjust the length of the straw being torn from the bottom of the bale and thus disbursed through the straw blower. The vertical adjustments to the rotor bars are made at both ends of the rotor bars 12 and 15 so they remain at all times parallel to each other and to the flail bar 14. These two adjustment mechanisms allow for fine adjustment of the rate of intake and outflow of straw to an application area, allowing greater speed in straw distribution and more even coverage of the ground cover.

FIG. 4 also discloses a screened walk board 24 for easier access to the climate controlled straw blower operator's cab 6 as well as access to the engine area. This screened walk board 24 is hingedly attached to the frame of the truck so that it might be folded into the truck and secured for transportation at highway speeds within legal width limits.

What is claimed is:

1. A vehicular system for loading, transporting, feeding a bale and distributing straw tom from the bale comprising:
a flat bed truck with a forward end and a rear end;
a boom arm mounted at the forward end of the flat bed truck;
a bale breakup and blower mechanism mounted at the rear end of the truck bed.

2. A vehicular system as defined in claim 1 wherein said bale is a large cylindrical bale of crop material weighing approximately 1,500 pounds.

3. A vehicular system as defined in claim 1 wherein said flat bed truck is operable at highway speed within highway weight and dimension limitations.

4. A vehicular system as defined in claim 1 wherein said boom arm terminates in a grapple adapted to the handling of large cylindrical bales.

5. A vehicular system as defined in claim 1 wherein said breakup and blower mechanism comprises:
a housing mounted toward the rear end of said flat bed truck;
an opening at the top of said housing to accept a large cylindrical bale;
a drive mechanism powered by an engine;
one or more free floating variable speed (clockwise and counter-clockwise) parallel rotor bars regularly interspersed with flanges or teeth rotatably attached to said housing and said drive mechanism;
one or more flail bars regularly interspersed with teeth or hinged flails rotatably attached to said housing and said drive mechanism;
a plurality of material feed restriction bars removably attached to said housing between said rotor bars and said flail bar.
a blower mechanism to receive the torn straw and eject it through a discharge spout;
a discharge spout rotatably and hingedly attached to the blower mechanism such that it may rotate approximately 300 degrees from the midline of the truck bed and raise and lower approximately 75 degrees in each direction from horizontal.

6. A vehicular system as defined in claim 1 wherein said truck bed has space between said boom arm and breakup and blower mechanism to provide storage for one or more large cylindrical bales while the system is in transport or in operation.

7. A vehicular system as defined in claim 1 wherein said truck bed may be stabilized during loading of large cylindrical bales onto the truck bed with a plurality of hydraulically operated stabilizers, said stabilizers being fixedly attached to said truck bed and able to be telescopingly deployed to firmly engage the ground below the truck bed. Said stabilizers may be retracted while the system in is transport or operation.

8. A vehicular system for loading, transporting, feeding a bale and distributing straw torn from the bale comprising:
a flat bed truck with a forward end with and a rear end;
an driver's cab at the forward end of the truck;
a boom arm with controls mounted at the forward end of the flat bed truck behind said cab;
a bale breakup and blower mechanism mounted at the rear end of the truck bed powered an engine;
a bale breakup and blower mechanism operator's cab located by the breakup and blower mechanism.

9. A vehicular system as defined in claim 8 wherein said bale is a large cylindrical bale of crop material weighing approximately 1,500 pounds.

10. A vehicular system as defined in claim 8 wherein said flat bed truck is operable at highway speed within highway weight and dimension limitations.

11. A vehicular system as defined in claim 8 wherein said boom arm terminates in a grapple adapted to the handling of large cylindrical bales.

12. A vehicular system as defined in claim 8 wherein said breakup and blower mechanism comprises:
a housing mounted toward the rear end of said flat bed truck;
an opening at the top of said housing to accept a large cylindrical bale;
a drive mechanism powered by an engine;
one or more free floating variable speed (clockwise and counter-clockwise) parallel rotor bars regularly interspersed with flanges or teeth rotatably attached to said housing and said drive mechanism;
one or more flail bars regularly interspersed with teeth or hinged flails rotatably attached to said housing and said drive mechanism;
a plurality of material feed restriction bars removably attached to said housing between said rotor bars and said flail bar.
a blower mechanism to receive the torn straw and eject it through a discharge spout;
a discharge spout rotatably and hingedly attached to the blower mechanism such that it may rotate approximately 300 degrees from the midline of the truck bed and raise and lower approximately 75 degrees from horizontal.

13. A vehicular system as defined in claim 8 wherein said driver's cab is weather proof.

14. A vehicular system as defined in claim 8 wherein said bale breakup and blower mechanism operator's cab is weather proof.

15. A vehicular system as defined in claim 8 wherein said driver's cab is climate controlled.

16. A vehicular system as defined in claim 8 wherein said bale breakup and blower mechanism operator's cab is climate controlled.

17. A vehicular system as defined in claim 8 wherein said bale breakup and blower mechanism operator's cab allows full 360 degree visibility of the work area and surrounding traffic.

18. A vehicular system as defined in claim 8 wherein said truck bed has space between said boom arm and breakup and blower mechanism to provide storage for one or more large cylindrical bales while the system is in transport or in operation.

19. A vehicular system as defined in claim 8 wherein said truck bed may be stabilized during loading of large cylindrical bales onto the truck bed with a plurality of hydraulically operated stabilizers, said stabilizers being fixedly attached to said truck bed and telescopingly deployed to firmly engage the ground below the truck bed. Said stabilizers may be retracted while the system in is transport or operation.

20. A vehicular system as defined in claim 8 wherein said engine is at least a 200 horse power internal combustion engine.

21. A vehicular system as defined in claim 8 wherein said drive mechanism is a poly chain belt drive system comprising a synchronized drive belt made of fiberglass and containing regularly distributed teeth which mesh with opposing teeth on each pulley that is driven by the belt.

22. A vehicular system as defined in claim 8 wherein said breakup and blower mechanism operator's cab is accessible by a walkway which is hingedly attached to the system such that said walkway may be raised and secured during transport or operation of the system.
